(19) United States
(12) Patent Application Publication
(10) Pub. No.: US 2017/0327002 A1
(43) Pub. Date: Nov. 16, 2017

(54) PULSE MODULATION FOR DRIVING AN ELECTRIC VEHICLE DRIVE AND FOR HARVESTING ENERGY

(71) Applicant: Leslie G. Lilly, Las Cruces, NM (US)

(72) Inventor: Leslie G. Lilly, Las Cruces, NM (US)

(21) Appl. No.: 15/152,078

(22) Filed: May 11, 2016

(51) Int. Cl. B60L 15/20; H02P 27/08; B60L 11/18; H02P 9/02; H02K 53/00

(52) U.S. Cl. CPC B60L 15/20; H02P 9/02; B60L 11/1809; H02P 27/08; B60L 11/1805; H02K 53/00; Y10S 74/09

(57) ABSTRACT

A vehicle with electric drive can employ a pulse width modulation technique to govern the amount of drive power provided to the vehicles wheels while also governing the charging power supplied to the storage device. For example, an electric motor, generator, and a drive shaft can all be linked such that when one spins, they all spin. The disclosed technique provides for rapidly switching from powering a wheel to charging the battery. In fact, the switching can be done rapidly enough that the battery can be charged between every pulse provided to the motor. This rapid switching provides for advanced capabilities in energy harvesting and vehicle weight distribution.

### TECHNICAL FIELD

Embodiments are related to electric vehicles, drivetrains, power electronics, and pulse width modulation.

### BACKGROUND

Current technology electric and hybrid vehicles use drive systems and power systems that switch between different distinct driving modes. While being driven, many all-electric vehicles simply stay in drive mode. Their batteries supply power to the wheels. More and more all-electric vehicles also have a regenerative braking mode. The vehicle generates power when the driver presses the brake pedal. The two modes are distinctly different. Hybrid vehicles have more modes that are distinctly different. For example, the vehicle's fossil fuel engine can charge the battery while also powering the wheels. For rapid acceleration, the vehicle can power the wheels with both the engine and the electric motor. In all of these cases, the vehicle switches between the different modes.

The current methods of switching between driving modes do not provide for fine grained transitions between different applications of vehicle and battery power. Systems and methods for fine grained transitions between different applications of vehicle and battery power are needed.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

The embodiments have at least one electric motor, at least one electric energy storage device, and at least one electric energy producing device. The energy storage device can be a battery, group of batteries, capacitor bank, or some other device or combination of devices that store electrical energy. Without losing generality, the energy storage device will hereinafter be referred to as a battery or batteries. The electric energy producing device is a transducer that accepts kinetic energy on an input shaft and produces electrical energy that can be used to charge the battery. Examples of such transducers are generators and rectified alternators. Without losing generality, the electric energy producing device will hereinafter be referred to as a generator. The motor can be a simple DC motor having a power connection and a ground connection or can be a more complicated motor having two or more power inputs to various windings. For ease of presentation, a simple DC motor will be assumed with the realization that one skilled in the art of electric motors can apply the teachings to power the more complicated motors.

The embodiments employ pulse modulation techniques. In pulse modulation, a signal is rapidly turned on and off over a period of time. The value of the signal, or the amount of power transmitted by the signal, is a function of how much time the signal spends turned on in relation to how much time it is turned off. This is called the duty cycle. Some modulation techniques use lots of pulse having the same length. For example, all the pulses can be about 0.05 seconds long. Eighteen pulses per second is a 90% duty cycle. Other techniques use pulse width modulation where the signal can stay high for different lengths of time. For example, a signal can stay high for 0.8 seconds for every second. Such a signal would have an 80% duty cycle.

The embodiments switch direct current (DC) electrical power on and off. Drive power signals have powered states and non-powered states. A powered state occurs when the wire carrying the signal is connected to the battery, perhaps by way of some transistors. The non-powered state occurs when the wire carrying the signal is not connected to the battery or to ground. It is floating. Charging signals are similar. The charging state occurs when the generator's power lead is electrically connected to the battery. The non-charging state occurs when the generator's power lead is not connected to the battery. The power lead should also float when not powering the battery.

Aspects of the embodiments address limitations and flaws in the prior art by pulse modulating the supply of electric power to motors and to batteries. The batteries supply electric power to the motor. A generator supplies electric power to the batteries. The motor and the generator can be mechanically linked so that turning one causes the other to turn. In other words, powering the motor causes both the generator and the motor to spin. The generator does not work against the motor because the charging power signal is always in the non-charging state when the drive power signal is in the powered state. The pulse width modulation techniques provide for connecting the generator to the battery whenever it is appropriate to do so and perhaps for just a moment or two. It is in this manner that the generator can sip energy back into the batteries without otherwise interrupting the vehicles operation.

It is a further aspect of embodiments that a modulating system or subsystem switches the drive power signals between the powered and non-powered states. The modulation subsystem also switches the charge power signal between the charging and non-charging states. The modulation subsystem has a battery connection, one or more drive connections, a charging connection, and a control input. Wires carrying drive power signals to the motor can be connected to drive connections. Wires carrying the charge power signal can be connected to the battery connection. The generator can be connected to the charging connection. The control input guides the modulation subsystem in producing the various duty cycles of the drive power signals and charge power signals. For example, a brake control can cause the charging power signal to have a very high duty cycle and the drive power signals to have very low duty cycles. An acceleration or speed control can cause the duty cycle of charging power signal to drop while that of the drive power signal increases.

A key aspect of the embodiments is that the voltage level of the drive power signals can be drastically different from those of the charging power signal. Pulse modulation ensures that the drive signals and the charge signal will never be present on the same wire at the same time. This is another advantage over the prior art in which motors and generators must be matched. In some embodiments, the batteries can be switched between being connected in serial to being connected in parallel depending on the charging or drive power signals. For example, the batteries can be switched to parallel connections when being charged and to series when powering the motor.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a high level diagram of a system using a pulse modulation technique to drive a wheel and to recharge a battery bank in accordance with aspects of the embodiments;

FIG. 2 illustrates a drive power signal and a charge power signal in accordance with aspects of the embodiments;

FIG. 3 illustrates a drive power signal, second drive power signal, a third drive power signal, and a charge power signal in accordance with aspects of the embodiments;

FIG. 4 illustrates a simplified high level diagram showing the electrical connectivity of a pulse modulation system powering a motor when the drive power signal is in the powered state in accordance with aspects of the embodiments;

FIG. 5 illustrates a simplified high level diagram showing the electrical connectivity of a pulse modulation system charging two batteries when the charge power signal is in the charging state in accordance with aspects of the embodiments;

FIG. 6 illustrates a high level diagram of a system using a pulse modulation technique to drive a motor having three windings and to recharge a battery bank in accordance with aspects of the embodiments;

FIG. 7 illustrates a high level diagram detailing select elements of a system using a pulse modulation technique to drive a motor and charge a battery in accordance with aspects of the embodiments;

FIG. 8 illustrates a high level diagram detailing select elements of a system using a pulse modulation technique to drive a motor and charge a battery in accordance with aspects of the embodiments;

FIG. 9 illustrates a high level diagram detailing select elements of a system using a pulse modulation technique to drive a motor and charge a battery in accordance with aspects of the embodiments;

FIG. 10 illustrates a high level diagram detailing select elements of a system using a pulse modulation technique to drive a motor and charge a battery in accordance with aspects of the embodiments; and

FIG. 11 illustrates a high level diagram detailing select elements of a system using a pulse modulation technique to drive a motor and charge a battery in accordance with aspects of the embodiments.

### DETAILED DESCRIPTION OF THE INVENTION

The particular values and configurations discussed in these non-limiting examples can be varied and are cited merely to illustrate embodiments and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

A vehicle with electric drive can employ a pulse width modulation technique to govern the amount of drive power provided to the vehicles wheels while also governing the charging power supplied to the storage device. For example, an electric motor, generator, and a drive shaft can all be linked such that when one spins, they all spin. The disclosed technique provides for rapidly switching from powering a wheel to charging the battery. In fact, the switching can be done rapidly enough that the battery can be charged between every pulse provided to the motor. This rapid switching provides for advanced capabilities in energy harvesting and vehicle weight distribution.

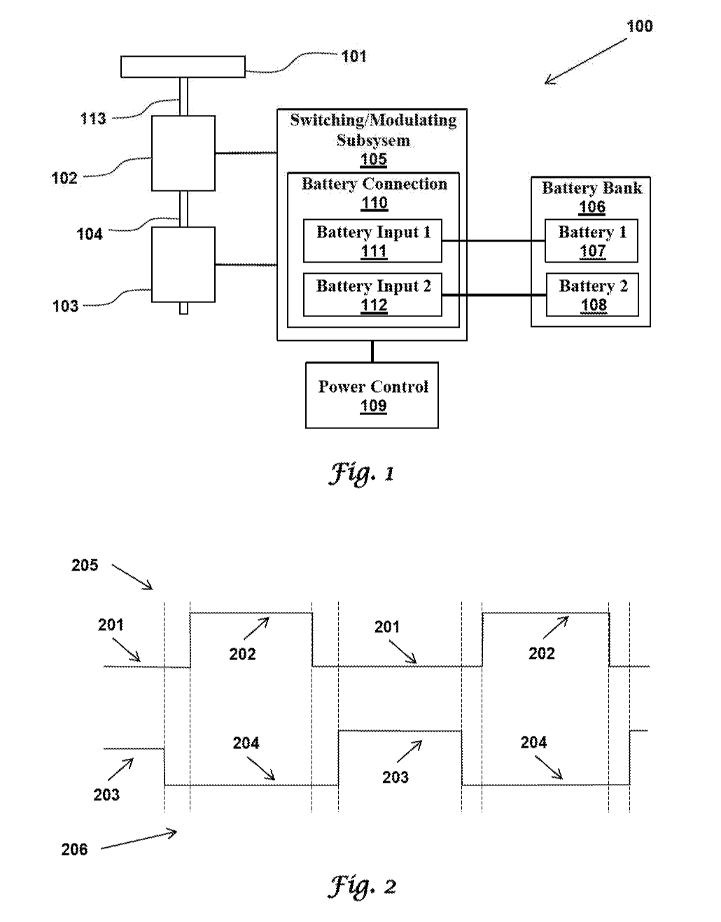

FIG. 1 illustrates a high level diagram of a system 100 using a pulse modulation technique to drive a wheel 101 and to recharge a battery bank 106 in accordance with aspects of the embodiments. The battery bank 106 is illustrated with two batteries, battery 1 107 and battery 2 108, although different embodiments can have a single battery or many more than two batteries. The battery bank 106 is electrically connected to a battery connection 110 to thereby provide electrical energy to a switching/modulating subsystem 105. Battery 1 107 is connected to battery input 1 111 and battery 2 108 is electrically connected to battery input 2 112. A power control 109 provides an input to the switching/modulating subsystem 105. The power control can cause the switching/modulating subsystem 105 to increase the flow of electrical energy from the battery bank 106 to an electric motor 102. The power control 109 can also cause the switching/modulating subsystem 105 to increase or decrease the flow of electrical energy from the generator 103 to the battery bank 106. FIG. 1 illustrates an output shaft 113 connecting the motor 102 and the drive wheel 101. Similarly, an input shaft 104 connects the generator 103 to the motor 102. As such, the generator 103 spins when the motor 102 spins, and the motor 102 spins when the drive wheel 101 spins. In some embodiments, the input shaft 104 and the output shaft 113 can be the same rod passing through the motor 102, generator 103, and connected to the drive wheel 101.

FIG. 2 illustrates a drive power signal 205 and a charge power signal 206 in accordance with aspects of the embodiments. The drive power signal 205 is switched between two states, a powered state 202 and a non-powered state 201. The charge power signal 206 is switched between two states, a charging state 203 and a non-charging state 204. The drive power signal 205 is always in the non-powered state 201 when the charge power signal 206 is in the charging state 203. The charge power signal 206 is always in the non-charging state 204 when the drive power signal 205 is in the powered state 202.

During the powered state 202, the batteries are connected to the motor via a switching device. A switching device is a device such as a power transistor, bank of power transistors, or other device that can turn the flow of energy off and on. The charge power signal 206 is in the non-charging state 204 while the drive power signal 205 is in the powered state 202. During the non-charging state 204, the generator is not connected to the batteries and the generator spins freely and, in many embodiments, powers nothing during the non-powered state.

During the charging state 203, the generator 103 is connected to the batteries 107, 108 via a switching device in the switching/modulating subsystem 105. Some embodiments can have a conditioning circuit that adjusts the charging voltage that is supplied to the batteries 107, 108. The generator 103 can power the conditioning circuit at all times or can be disconnected from the conditioning circuit when charge power signal 206 is in the non-charging state 204. The drive power signal 205 is in the non-powered state 201 while the charge power signal 206 is in the charging state 203. During the non-powered state 201, the motor 102 is not connected to the batteries 107, 108 and the motor 102 spins freely.

Embodiments can have a cruise mode. In cruise mode, the drive power signal 205 and the charge power signal 206 are held in the non-powered state 201 and non-charging state 204, respectively. During cruise mode the vehicle moves forward under its momentum and the drive wheel 101 spins. The motor 102 and the generator 103 also spin unless they are mechanically disengaged by a clutch or other disengagement device.

FIG. 2 shows a slight time difference between the charging state 203 and the powered state 202. The timings of FIG. 2 are not to scale and, on a scale drawing, the timings can be unnoticeably small. The voltage level of the powered state can be not equal to the voltage level of the charging state. In fact, the voltage level of the charging state can change from pulse to pulse, as seen in FIG. 2, and can even vary during a pulse because the generator output voltage can vary. In most embodiments, the voltage level of the powered state is nearly constant because batteries provide near constant output voltages. Embodiments with a voltage conditioning circuit between the batteries and the motor can have a varying powered state voltage.

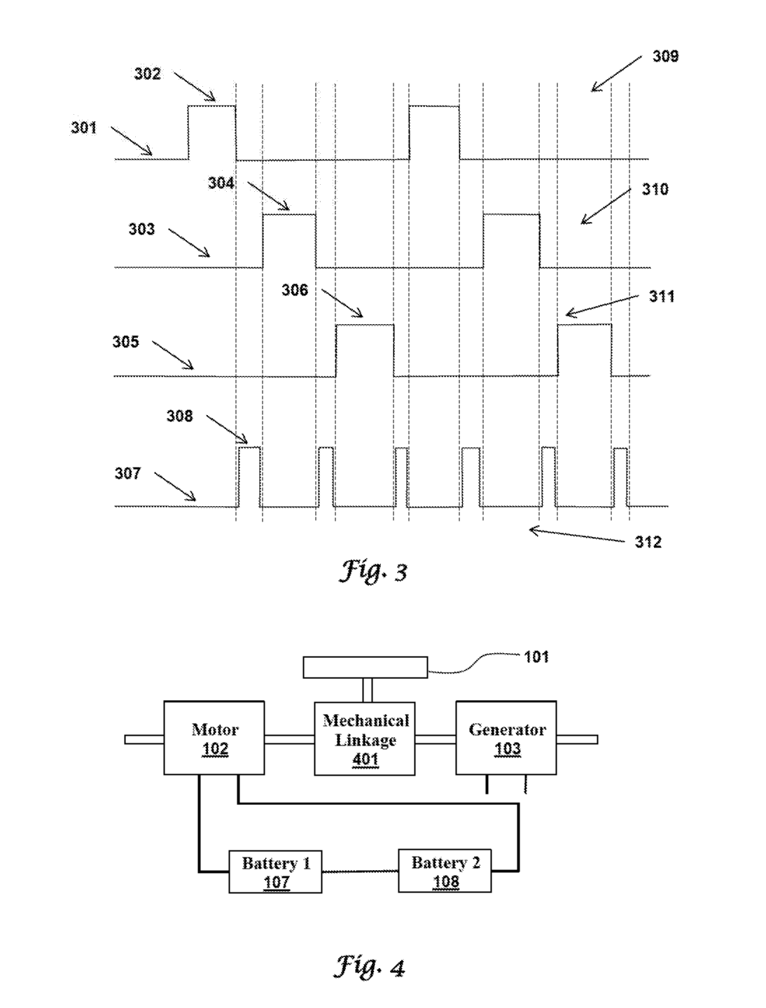

FIG. 3 illustrates a drive power signal 309, second drive power signal 310, a third drive power signal 311, and a charge power signal 312 in accordance with aspects of the embodiments. FIG. 3 illustrates a pulse modulation technique that is very similar to that of FIG. 2 in that the generator is connected to the batteries only when none of the drive power signals 309, 310, 311 is connected to any battery. The drive power signal 309 switches between a powered state 302 and a non-powered state 301. The second drive power signal 310 switches between a second powered state 304 and a second non-powered state 303. The third drive power signal 311 switches between a third powered state 306 and a third non-powered state 305. The charge power signal 312 switches between a charging state 308 and a non-charging state 307. Three drive signals can be used when the motor has three windings. In many applications, each of the three windings is connected to two drive signals with one drive signal connected to the batteries' positive output and the other signal connected to the batteries negative or ground output. Note that, as used in this application, the phrase “not connected to the batteries” can mean completely disconnected or can mean connected to only one terminal—typically the negative or ground terminal.

FIG. 4 illustrates a simplified high level diagram showing the electrical connectivity of a pulse modulation system powering a motor 102 when the drive power signal is in the powered state in accordance with aspects of the embodiments. FIG. 4 is intended to be illustrative only because the switching and modulation subsystem is not shown. In the embodiment of FIG. 4, the batteries are connected in series and to when the drive power signal is in the powered state. A mechanical linkage 401 transfers energy between the motor 102, drive wheel 101, and generator 103. Here, the motor 102 is powered and is spinning the drive wheel 101 and the generator 103. Note that the batteries 107, 108 are shown connected in series such that a higher voltage drives the motor 102. Other embodiments can have the batteries in parallel such that a higher current drives the motor. Battery banks can be used with sets and subsets of batteries connected in series or parallel, depending on the needs of the system.

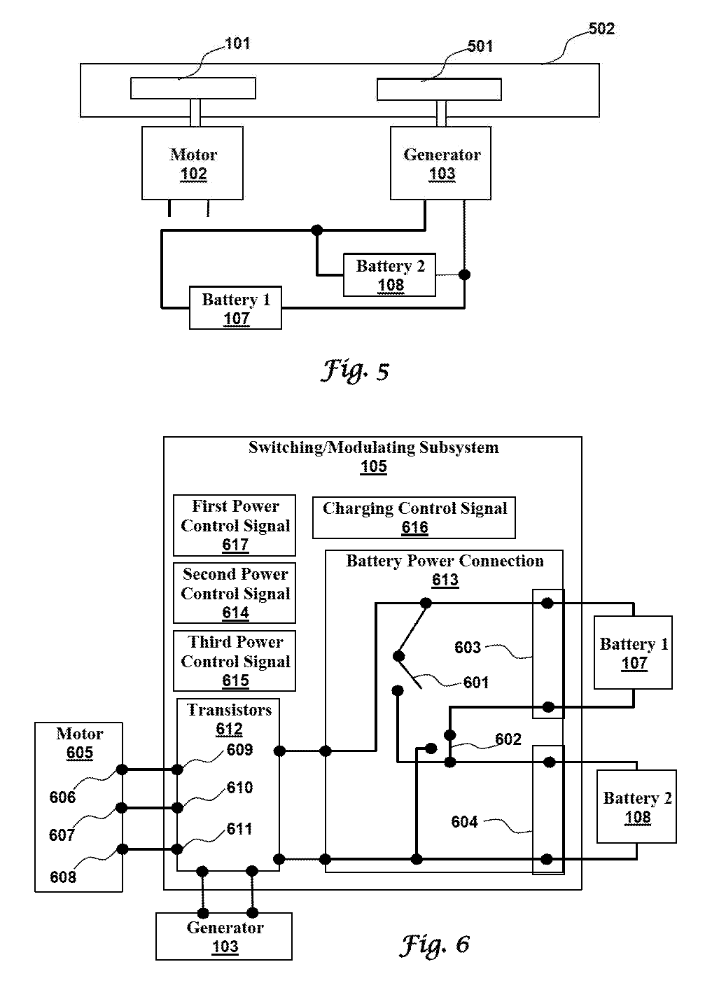

FIG. 5 illustrates a simplified high level diagram showing the electrical connectivity of a pulse modulation system charging two batteries when the charge power signal is in the charging state in accordance with aspects of the embodiments. FIG. 5 is also intended to be illustrative only because the switching and modulation subsystem is not shown. In the embodiment of FIG. 5, the batteries 107, 108 are connected in parallel to the generator 103 which is being driven by wheel 501. Wheel 501 is spun by the roadway 502 as the vehicle moves forward. In this example, the roadway 502 provides the mechanical linkage between the generator 103 and the motor 102. As with FIG. 4, other embodiments can have different combinations of batteries in series and parallel can be used.

FIG. 6 illustrates a high level diagram of a system using a pulse modulation technique to drive a motor 605 having three windings and to recharge a battery bank having two batteries 107, 108 in accordance with aspects of the embodiments. The battery power connection 613 illustrates one way that switches 601, 602 can dynamically connect and reconnect the batteries in parallel and series configurations. When switch 601 is open and switch 602 is closed, the batteries 107 and 108 are connected in series. The batteries would be connected in parallel if switch 601 were closed and switch 602 moved to its other terminal. The batteries 107, 108 are connected to the battery power connection 613 through battery connections 601, 602. A charge control signal 616 can cause the switches 601, 602 to switch. As discussed above, the switches 601, 602 can by transistors, banks or combinations of transistors, or other devices.

The charging control signal 616 can also drive transistors 612 to thereby cause the generator 103 to be connected or disconnected from the batteries. The relationship between the charge control signal 616 and a charge power signal 312 is the charge control signal 616 can operate switches, such as transistors 612, to thereby produce the charge power signal. In a similar manner, first power control signal 617 can operate transistors 612 to thereby produce drive power signal 309, second power control signal 614 can operate transistors 612 to thereby produce second drive power signal 310, and third power control signal 615 can operate transistors 612 to thereby produce third drive power signal 311. The drive power signals are passed from the modulating subsystem 107 to the motor 605. Connection 609 can pass a drive power signal to connection 606, connection 610 can pass a drive power signal to connection 607, and connection 611 can pass a drive power signal to connection 608.

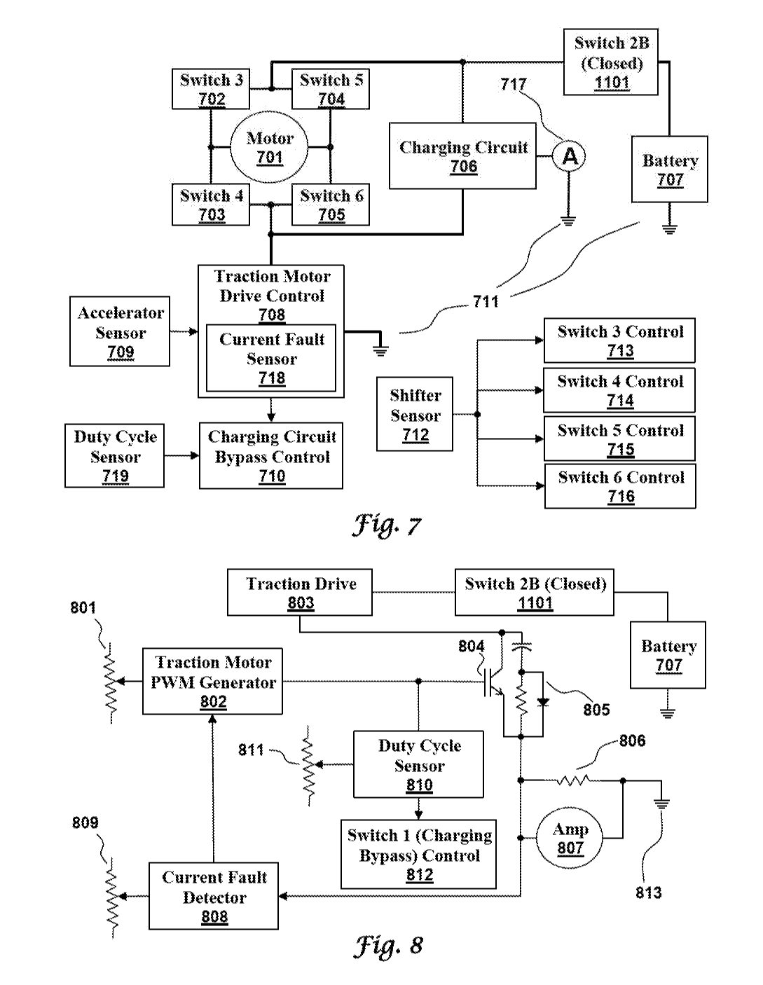

FIG. 7 illustrates a high level diagram detailing select elements of a system using a pulse modulation technique to drive a motor 701 and charge a battery 707 in accordance with aspects of the embodiments. A shift sensor 712 can control the state of four switches arranged in an H bridge to control the direction of motor 701. Shift sensor 712 can provide an output to switch 3 control 713, switch 4 control 714, switch 5 control 715, and switch 6 control 716. The four switch controls can open and close four switches: switch 3 702, switch 4 703, switch 5 704, and switch 6 705. As an example, motor 701 can turn clockwise when switch 3 702 and switch 6 705 are closed and can turn counterclockwise when switch 5 704 and switch 4 703 are closed. The shift sensor 712 can sense settings including forward, reverse, and neutral with the different settings selectively opening and closing switches in the H bridge. The following discussion generally assumes that the shift sensor is in forward or reverse such that current can flow through the motor.

Traction motor drive control 708 can control the flow of current from battery 707, through motor 701, and then to ground 711. As discussed above, a PWM scheme drives the motor with longer pulses allowing more current to flow through traction motor drive control 708 and then to ground 711. An accelerator sensor 709 can inform the traction motor drive control 708 as to how wide to make the PWM pulses. In general, when the PWM pulse is “on” the motor current pass through traction motor drive control 708 and then to ground 711, but when the PWM pulse is “off” the motor drive current is unable to flow through traction motor drive control 708 to ground 711. Current fault sensor 718 can monitor the amount of current flowing through traction motor drive control 708, can read the charging current flowing through ammeter 717, and can cut off the current flowing through traction motor drive control 708 or can reduce the PWM pulse widths when the motor drive current is above a threshold value.

A charging circuit 706 can be energized by motor 701 when certain conditions exist such as the vehicle's brakes being applied or a cruising speed being reached. The current passing through motor 701 preferentially passes through traction motor drive control 708 whenever traction motor drive control 708 allows such a flow. Whenever the traction motor drive control does not allow such a current flow, motor 701 can instead drive current through charging circuit 706 which then charges the battery 707.

In certain conditions, the traction motor drive control 708 can trigger charging circuit bypass control 710 such that the charging circuit 706 does not charge the battery 707. For example, the charging circuit bypass control can be triggered when the duty cycle of the motor drive PWM signal is above a certain threshold such as 85%. Duty cycle sensor 719 is shown passing a duty cycle measurement to charging circuit bypass control 710.

FIG. 8 illustrates a high level diagram detailing select elements of a system using a pulse modulation technique to drive a motor and charge a battery 707 in accordance with aspects of the embodiments. More specifically, example circuitry for traction motor drive control 708 and related components is provided. Traction drive 803 can include the H bridge and motor 701 of FIG. 7. A solid state switch such as a power transistor or insulated gate bipolar transistor (IGBT) 804 can control the flow of current from traction drive 803 to ground 813. Here, an IGBT is illustrated although other switching technologies can be used. A snubber circuit 805 is illustrated because snubbers are often helpful in such switching configurations. The current can pass through resistor 806 and the voltage drop measured by sensor 807 to thereby measure the current flowing though solid state switch 804. Traction motor PWM generator 802 can provide a PWM signal to the gate of IGBT 804 to cause it to turn on and off. Traction motor PWM generator 802 can receive an input, here illustrated as the position of a potentiometer 801 that indicates throttle position. Those familiar with electrical circuits know that potentiometers are often used as analog inputs with a voltage indicating the potentiometer's wiper position.

Current fault detector 808 can compare the current flow to a trigger point and, when the trigger point is exceeded, informs the traction motor PWM generator 802 to reduce the pulse widths, thereby reducing the current flow, or to shut off, thereby stopping the current flow. Potentiometer 801 is illustrated as providing a trigger point input to traction motor PWM control 802. Those practiced in the arts of circuitry or electronics know of a plethora of means for providing a set point or trigger and it is therefore stressed that potentiometers are illustrated here only as non-limiting examples.

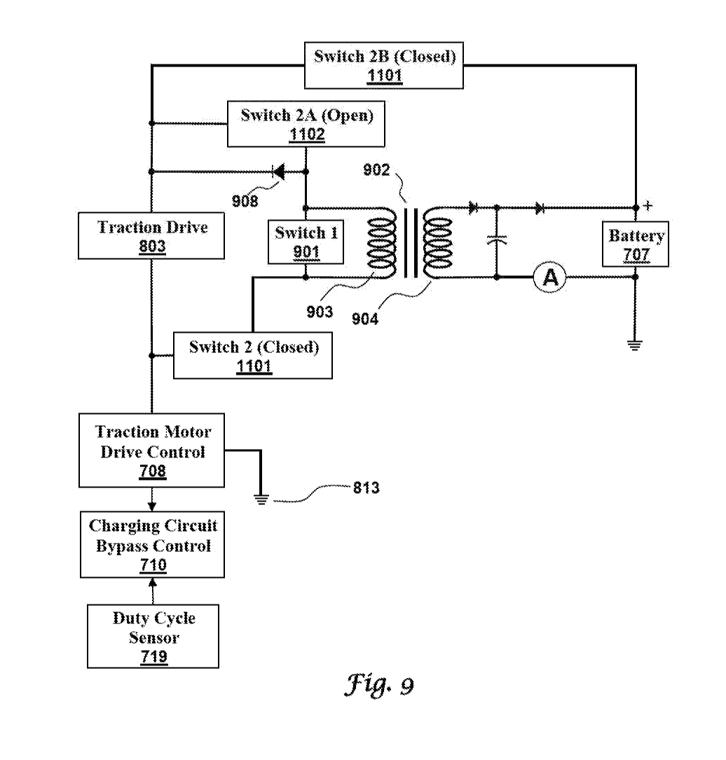

Potentiometer 811 is illustrated as providing a set point or trigger point to duty cycle sensor 810. The duty cycle sensor can measure the duty cycle using any of a number of well-known means such as integrating with a capacitor, counting, and comparing time periods, or some other means to measure the duty cycle. An alternative is for the traction motor PWM control to directly output a duty cycle value. Such capabilities exist for certain types of PWM generators such as those implemented with microcontrollers. Note that it is known in the art for a single microcontroller to concurrently generate multiple PWM signals while also measuring analog values on A/D input pins, outputting analog value on D/A output pins, and handling digital I/O functions. In any case, duty cycle sensor 810 can control a charging circuit bypass. As illustrated here, duty cycle sensor 810 can control switch 1 901 of FIGS. 9-11 by means of switch 1 control 812.

FIG. 9 illustrates a high level diagram detailing select elements of a system using a pulse modulation technique to drive a motor and charge a battery 707 in accordance with aspects of the embodiments. More specifically, aspects of the charging system that can be active during “low” sections of the motor drive PWM pulse are illustrated. When the motor drive PWM pulse is high, current can flow from battery 707 through traction 803 through traction motor drive control 708 to ground 813. When the motor drive PWM pulse is low, the current cannot flow to ground 813 and battery 707 stops driving the motor. The motor, however, can drive electrical current though primary winding 903 of transformer 902 thereby energizing secondary winding 904 which charges battery 707. Switch 1 901 can be seen to, when closed, provide a path for the current to bypass primary winding 903. Diode 908 prevents current directly from the battery 707 or secondary winding 904 from passing through the primary winding 903.

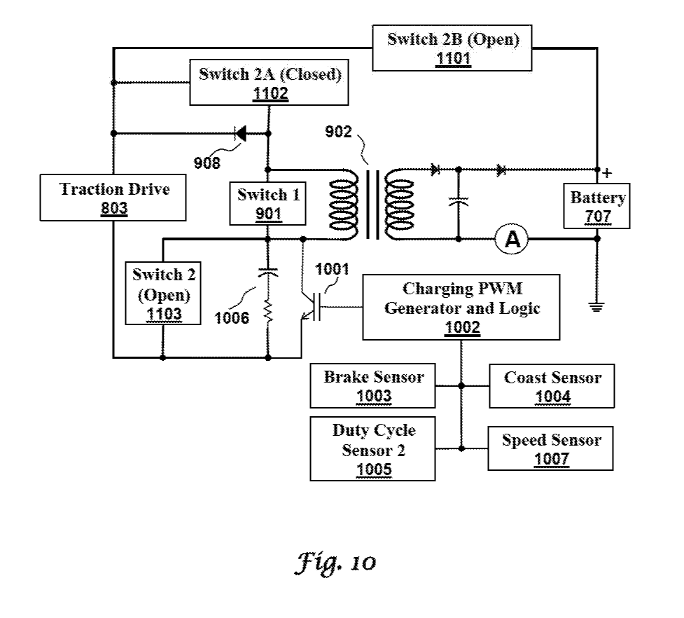

FIG. 10 illustrates a high level diagram detailing select elements of a system using a pulse modulation technique to drive a motor and charge a battery 707 in accordance with aspects of the embodiments. The circuit illustrated in FIG. 10 shows a different aspect of the charging circuit of the other figures. Here, the solid state switch 804 of the drive circuitry is off because the motor drive PWM signal is being held in an off state. Therefore, the drive circuitry of FIGS. 7-9 is not shown because it is, in essence, switched out. The motor 701 is turning and generating current that can flow through the primary winding of the transformer 902 when solid state switch 1001 is conducting. It is well known that transformers require AC current or switching current to operate and that DC current simply burns out the windings. It is for that reason that solid state switch 1001 is turned off and on by a PWM signal, the charging PWM signal, produced by charging PWM generator and logic 1002. The charging PWM signal can be produced when a brake sensor 1003 indicates that a person is trying to stop or slow the vehicle by pressing the brake pedal. The charging PWM signal can be produced or inhibited in response to duty cycle sensor 2 1005, a coast sensor 1004, or speed sensor 1007. Speed sensor 1007 can detect the vehicle's speed. Coast sensor 1004 can receive vehicle speed information or a vehicle speed signal from speed sensor 1007, can detect that a desired speed, perhaps set by a “cruise control” or speed controller, has been met or exceeded and that there is an opportunity to charge the battery. Element 1006 of FIG. 10 is another snubbing circuit that is shown because switching element 1001 is illustrated as an IGBT. Other switching technologies may or may not be helped by a snubber circuit.

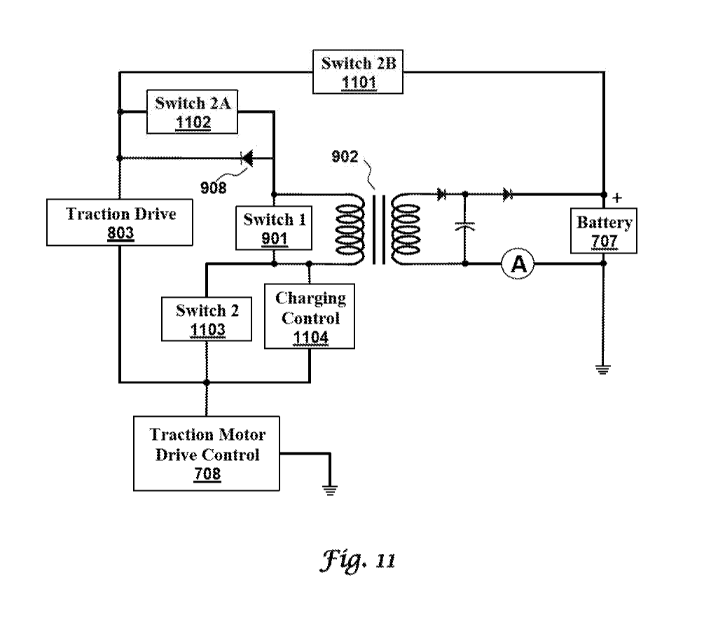

FIG. 11 illustrates a high level diagram detailing select elements of a system using a pulse modulation technique to drive a motor and charge a battery 707 in accordance with aspects of the embodiments. More specifically, it is shown that a single control signal can switch a circuit from the configuration of FIG. 9 to that of FIG. 10. Note that charging control 1104 is introduced and can, for example, include elements 1001-1006 of FIG. 10.

In a first state, switch 2 1103 and switch 2B 1101 are closed and switch 2A 1102 is open. In the first state, the circuit of FIG. 11 can operate as that illustrated in FIG. 9. In a second state, switch 2 1103 and switch 2B 1101 are open and switch 2A 1102 is closed. In the second state, the circuit of FIG. 11 can operate as that illustrated in FIG. 10.

Transformer 902 has been used in the examples discussed herein for clarity. The charging circuit can instead be an isolated switch mode power converter, also known as an isolated switched power converter, which is a well-known technology that is commonly used instead of transformers in many applications such as in power supplies that convert AC power into DC power.

Having described the embodiments in the figures, a higher level overview can be understood. When a vehicle is being driven, counter electromotive force (CEMF) is PWM switched and generated magnetic fields generated during PWM binary one (such as that of traction motor PWM generator 802) in the motor's magnetic core mass and temporarily stored in the core as magnetic inductive energy due to PWM switching are released during PWM binary zero as CEMF through the freewheeling diode (illustrated as element 908), through the primary winding 903 of transformer 902, through switch 2 1103, and through the H-bridge elements (switches 3-6, elements 702-705) that are connected to the armature of traction motor 701.

Kinetic energy can be harvested when the armature of traction motor 701 is freewheeling due to vehicle inertia. For example, when traction motor PWM generator 802 produces no pulses, IGBT 804 is thereby held off. No CEMF is generated and therefore all generated EMF from motor 701 is the same polarity as provided by battery 707 through switch 2B 1101, and through the H bridge elements (switches 3-6, elements 702-705) that are connected to the armature of traction motor 701. Battery charging while freewheeling is discussed above where FIG. 10 is described.

It should be noted that the sensors, triggers, set points, and signal generators discussed herein can be implemented using a wide range of technologies ranging for analog potentiometers and relays to solid state sensors and microcontrollers. Those practiced in the arts of electronics realize that such implantations are simply variations on a theme. It should also be noted that the embodiments disclosed herein provide novel circuitry for using PWM signals to switch circuit elements that can carry high currents for powering motors and for harvesting energy from the motors to charge batteries.

It will be appreciated that various of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system comprising:
a drive wheel;
an electric motor that supplies motive power to the drive wheel;
a direct current (DC) transducer comprising an input shaft that is coupled to the electric motor wherein spinning the input shaft causes the DC transducer to produce DC electric energy;
an electric energy store that stores DC electric energy;
a drive power signal that switches between a powered state and a non-powered state, wherein the drive power signal is pulse width modulated, wherein the drive power signal supplies power to the electric motor when the drive power signal is in the powered state, wherein the drive power signal supplies no power to the electric motor when the drive power signal is in the non-powered state, and wherein the drive power signal receives electrical energy from the electric energy store;
a charge power signal that switches between a charging state and a non-charging state, wherein the charge power signal is always in the non-charging state when the drive power signal is in the powered state, wherein the charge power signal supplies electric energy to the electric energy store when the charge power signal is in the charging state, wherein the charge power signal does not supply electric energy to the electric energy store when the charge power signal is in the non-charging state, and wherein the charge power signal receives electrical energy from the DC transducer; and
a modulating subsystem that modulates the drive power signal and the charge power signal wherein the charge power signal is always in the non-charging state when the drive power signal is in the powered state and wherein the charge power signal can be in the non-charging state when the drive power signal is in the non-powered state.

2. The system of claim 1 further comprising a second drive power signal that switches between a second powered state and a second non-powered state, wherein the second drive power signal is pulse width modulated, wherein the second drive power signal supplies power to the electric motor when the second drive power signal is in the second powered state, wherein the second drive power signal supplies no power to the electric motor when the second drive power signal is in the second non-powered state, wherein the second drive power signal receives electrical energy from the electric energy store, and wherein the charge power signal is always in the non-charging state when the second drive power signal is in the second powered state.

3. The system of claim 2 further comprising a third drive power signal that switches between a third powered state and a third non-powered state, wherein the third drive power signal is pulse width modulated, wherein the third drive power signal supplies power to the electric motor when the third drive power signal is in the third powered state, wherein the third drive power signal supplies no power to the electric motor when the third drive power signal is in the third non-powered state, wherein the third drive power signal receives electrical energy from the electric energy store, and wherein the charge power signal is always in the non-charging state when the third drive power signal is in the third powered state.

4. The system of claim 3 further comprising a non-powered wheel wherein the non-powered wheel is coupled to the drive wheel by a roadway;
wherein the input shaft is coupled to the non-powered wheel;
wherein the drive power signal is modulated based on a power control to thereby control the speed, acceleration, and deceleration of the system;
wherein the charge power signal is pulse width modulated;
wherein the charge power signal is modulated based on a braking control to thereby slow the system;
wherein the electric energy store comprises a plurality of batteries; and
wherein at least two of the batteries are connected in series whenever the drive power signal is in the powered state and are connected in parallel whenever the charge power signal is in the charging state.

5. The system of claim 1 further comprising a non-powered wheel wherein the non-powered wheel is coupled to the drive wheel by a roadway, and wherein the input shaft is coupled to the non-powered wheel.

6. The system of claim 1 wherein the drive power signal is modulated based on a power control to thereby control the speed and acceleration of the system.

7. The system of claim 1 wherein the charge power signal is pulse width modulated.

8. The system of claim 1 wherein the drive power signal is pulse width modulated to enter the powered state for no longer than 0.2 seconds before entering the non-powered state for no longer than 0.2 seconds and wherein a control signal causes the charge power signal to enter the charging state between consecutive non-powered states.

9. The system of claim 1 wherein the electric energy store comprises a plurality of batteries.

10. The system of claim 9 wherein at least two of the batteries are connected in series whenever the drive power signal is in the powered state.

11. The system of claim 10 wherein the at least two of the batteries are connected in parallel whenever the charge power signal is in the charging state.

12. A system comprising:
a first transducer that converts electrical energy into rotational kinetic energy of a first shaft;
a second transducer that accepts rotational energy from a second shaft and converts the rotational energy into electric energy wherein the second shaft is driven by the first shaft;
an electric energy store that stores electric energy;
a drive power signal wherein the first transducer is powered by the drive power signal, wherein the drive power signal comprises a pulse train that switches between a powered state and a non-powered state, wherein the drive signal is pulse width modulated to thereby have a time varying duty cycle, wherein increasing the duty cycle increases the first transducer's output power, and wherein the first transducer obtains electrical energy from the electric energy store;
a charge power signal that switches between a charging state and a non-charging state, wherein the charge power signal is always in the non-charging state when the drive power signal is in the powered state, wherein the charge power signal supplies electric energy to the electric energy store when the charge power signal is in the charging state, wherein the charge power signal does not supply electric energy to the electric energy store when the charge power signal is in the non-charging state, and wherein the charge power signal receives electrical energy from the second transducer; and
a modulating subsystem that modulates the drive power signal and the charge power signal wherein the charge power signal is always in the non-charging state when the drive power signal is in the powered state and wherein the charge power signal can be in the non-charging state when the drive power signal is in the non-powered state.

13. The system of claim 12 further comprising:
a second drive power signal that switches between a second powered state and a second non-powered state;
a third drive power signal that switches between a third powered state and a third non-powered state;
a switching apparatus comprising a plurality of transistors wherein the plurality of transistors switch the charge power signal between a charging state and a non-charging state;
wherein the second drive power signal and the third drive power signal are pulse width modulated;
wherein the second drive power signal supplies power to the first transducer when the second drive power signal is in the second powered state;
wherein the third drive power signal supplies power to the first transducer when the third drive power signal is in the third powered state;
wherein the second drive power signal supplies no power to the electric motor when the second drive power signal is in the second non-powered state;
wherein the third drive power signal supplies no power to the electric motor when the third drive power signal is in the third non-powered state;
wherein the second drive power signal and the third drive power signal receive electrical energy from the electric energy store to thereby power the first transducer; and
wherein the charge power signal is always in the non-charging state when the second drive power signal or the third drive power signal is in the powered state.

14. A system comprising:
a battery connection;
a first drive connection;
a charging connection;
a control input;
a first power control signal comprising a plurality of on/off pulses wherein the first power signal is produced by the system, and wherein the first power control signal is modulated based on the control input;
a charging signal comprising a further plurality of on/off pulses wherein the charging signal is produced by the system, wherein the charging signal is modulated based on the control input, and wherein the charging signal is off whenever the first power control signal is on; and
a switching apparatus that connects the battery connection to the first drive connection whenever the first power control signal is on and that connects the battery power connection to the charging connection whenever the charging signal is on.

15. The system of claim 14 further comprising:
a second drive connection and a third drive connection;
a second power control signal comprising a yet further plurality of on/off pulses wherein the second power signal is produced by the system, and wherein the second power control signal is modulated based on the control input;
a third power control signal comprising a still yet further plurality of on/off pulses wherein the third power signal is produced by the system, and wherein the third power control signal is modulated based on the control input;
wherein the charging signal is off whenever the second power signal is on or the third power signal is on; and
wherein the switching apparatus connects the battery power connection to the second drive connection whenever the second power control signal is on and connects the battery power connection to the third drive connection whenever the third power control signal is on.

16. The system of claim 15 wherein the switching apparatus comprises a plurality of transistors wherein the plurality of transistors switchably connect the battery power connection to the first drive connection, the second drive connection, the third drive connection, and the charging connection.

17. The system of claim 14 wherein the first power control signal and the charging signal are pulse width modulated.

18. The system of claim 16 wherein the battery connection comprises two battery inputs wherein the battery inputs are connected in parallel whenever the charging signal is on and wherein the battery inputs are connected in series whenever the first power control signal is on.

19. The system of claim 18 further comprising:
two batteries connected to the two battery input connections;
an electric motor comprising an output shaft wherein the electric motor is electrically connected to the first drive connection, the second drive connection, and the third drive connection; and
a transducer comprising an input shaft wherein the transducer converts rotational energy to electric energy, and wherein the transducer is electrically connected to the charging connection.

20. The system of claim 19 wherein the system is a wheeled vehicle comprising:
at least one drive wheel providing motive power to the wheeled vehicle; and
at least one mechanical linkage that causes the at least one drive wheel, the input shaft, and the output shaft to spin at the same time.
